(19) United States
(12) Patent Application Publication
(10) Pub. No.: US 2011/0121971 A1
(43) Pub. Date: May 26, 2011

(54) ILLUMINATED WALL-MOUNTABLE OBJECT CONTROLLED BY PIR SENSOR

(75) Inventor: Kevin Michael Ross, Edwardsville, KS (US)

(73) Assignee: Kevin Michael Ross, Edwardsville, KS (US)

(21) Appl. No.: 12/945,857

(22) Filed: Nov. 13, 2010

Related U.S. Application Data
(60) Provisional application No. 61/263,583, filed on Nov. 23, 2009.

(51) Int. Cl. G08B 13/00

(52) U.S. Cl. 340/541

(57) ABSTRACT

An ornamental wall-mounted or freestanding décor object, such as a cross or crucifix, which utilizes LEDs or some other form of lighting technology to illuminate itself in a decorative and aesthetic fashion when a PIR (Passive Infrared) motion sensor detects motion in the vicinity of the object.

### REFERENCES CITED

### U.S. Patent Documents

U.S. Pat. No. 1,294,279-February 1919-Kugel
U.S. Pat. No. 1,614,703-January 1927-Wolfers
U.S. Pat. No. 2,325,883-August 1943-Schleif
U.S. Pat. No. 2,958,762-November 1960-Cheney
U.S. Pat. No. 4,823,051-April 1987-Young
U.S. Pat. No. 4,703,171-October 1987-Kahl
U.S. Pat. No. 5,015,994-May 1991-Hoberman, Kirwan, Gordon
U.S. Pat. No. 5,255,170-October 1993-Plamp
D338081-March 1993-Klaffer
U.S. Pat. No. 5,258,899-November 1993-Chen
U.S. Pat. No. 5,282,118-January 1994-Lee, W.
U.S. Pat. No. 5,434,764-July 1995-Lee, S.
U.S. Pat. No. 5,442,532-August 1995-Boulos
U.S. Pat. No. 5,455,564-October 1995-Hsiao
U.S. Pat. No. 5,489,891-February 1996-Diong
U.S. Pat. No. 5,489,827-February 1996-Xia
U.S. Pat. No. 5,564,816-October 1996-Arcadia
U.S. Pat. No. 5,575,557-November 1996-Huang
U.S. Pat. No. 5,586,048-December 1996-Coveley
U.S. Pat. No. 5,590,953-January 1997-Haslam
U.S. Pat. No. 5,626,417-May 1997-McCavit
U.S. Pat. No. 5,649,761-July 1997-Sandell
U.S. Pat. No. 5,662,411-September 1997-Haslam
U.S. Pat. No. 5,699,243-December 1997-Eckel
U.S. Pat. No. 5,763,872-June 1998-Ness
U.S. Pat. No. 5,946,209-August 1999-Eckel et al
U.S. Pat. No. 6,151,529-November 2000-Batko
U.S. Pat. No. 6,390,648-May 2002-Privas
U.S. Pat. No. 6,402,338-June 2002-Mitzel
U.S. Pat. No. 6,943,687-September 2005-Lee, W.
U.S. Pat. No. 6,948,831-September 2005-Naqvi
U.S. Pat. No. 7,118,242-October 2006-Yulee
U.S. Pat. No. 7,204,614-April 2007-Hanis
U.S. Pat. No. 7,375,313-May 2008-Lee, W.

### BACKGROUND OF THE INVENTION

1. Field of the Invention

The present invention relates generally to the field of decorative and illuminating objects or signs. More specifically, it relates to home décor or ornamental wall objects and freestanding objects illuminated by motion sensing technology for decorative purposes. A low power motion sensor, such as a PIR (Passive Infrared) motion sensing device, built into the object allows the object to emit an aesthetically pleasing radiant illumination pattern around or in the object using a light source, such as LEDs, when a person approaches the object. The aesthetically pleasing radiant illumination pattern around or in the object serves the purpose of drawing the passer-by's attention to the object.

2. Description of Prior Art

Motion sensing technology has been utilized for years to control general illumination light sources such as floodlights, interior and exterior building lighting, and nightlights. It is an object of the present invention to utilize motion sensing and lighting technology not for general illumination of a path, walkway, or area, but for decorative purposes: to add an aesthetically pleasing self-illumination operation within or around a decorative wall object, such as a cross or crucifix. A primary purpose of the illumination is to draw the passer-by's attention to the object.

Decorative illuminating objects, such as graveside memorials, have also been around for years. It is an object of the present invention to improve on these inventions through the incorporation of motion sensing technology to allow the object to illuminate only when a person approaches the object in order to save energy and extend battery life.

It is another object of the present invention to utilize ultra low power microcontroller and electronics technology in order to allow the illuminating wall mountable object to operate from a battery source without requiring a nearby AC power outlet and visually detracting power cord.

Yet another object of the present invention is to utilize the microcontroller and electronics to produce precisely controlled, calculated, and timed decorative light dispersion patterns within and around the illuminating wall mountable object.

A further object of the electronic controls of the present invention is to allow for the user to select the modes of operation, the length of time the object illuminates, and other variables such as the color of the light illuminated by the object.

An object of the mechanical design of the present invention is the removable back wall mountable bracket that allows for ideal spacing of the object when mounting to a wall. This spacing allows for the ideal illumination pattern on the wall or area surrounding the object.

The following art defines the present state of this field:

Kugel, U.S. Pat. No. 1,294,279 describes an illuminated crucifix memorial, but it is not controlled by motion sensing technology. Similarly, Wolfers, U.S. Pat. No. 1,614,703, Schleif, U.S. Pat. No. 2,325,883, Cheney, U.S. Pat. No. 2,958,762, Klaffer, U.S. Patent number D338081, and Yulee, U.S. Pat. No. 7,118,242, all describe illuminated crosses, memorials, and art objects of various types, but none are controlled by motion sensing technology.

Young, U.S. Pat. No. 4,823,051, describes an infrared actuated control switch assembly for general illumination in a room, such as a ceiling light; all of which is controlled by a PIR—passive infrared sensor. But the sensor fixture is not used for decorative illumination of an art object. Similarly, Kahl, U.S. Pat. No. 4,703,171 describes a lighting control system for general illumination, not for decorative illumination of an art object.

Plamp, U.S. Pat. No. 5,255,170 and Arcadia, U.S. Pat. No. 5,564,816, describe an illuminated memorial controlled by an ambient light sensor, but not a motion sensor.

Chen, U.S. Pat. No. 5,258,899, describes a motion sensor lighting controller for general and exterior illumination, but not for decorative illumination of art. Similarly, Lee, W., U.S. Pat. Nos. 5,282,118, 7,375,313, and 6,943,687, Lee, S., U.S. Pat. No. 5,434,764, Boulos, U.S. Pat. No. 5,442,532, Chin-hsiung, U.S. Pat. No. 5,455,564, Huang, U.S. Pat. No. 5,575,557, Haslam, U.S. Pat. Nos. 5,590,953 and 5,662,411, McCavit, U.S. Pat. No. 5,626,417, Sandell, U.S. Pat. No. 5,649,761, Naqvi, U.S. Pat. No. 6,948,831, Hoberman, Kirwan, and Gordon, U.S. Pat. No. 5,015,994, Diong, U.S. Pat. No. 5,489,891, and Coveley, U.S. Pat. No. 5,586,048, all describe lighting fixtures with integrated motion detectors for general and exterior lighting illumination, but not for the purpose of decorative art object illumination.

Xia, U.S. Pat. No. 5,489,827, describes a light controller with occupancy sensor that is intended to control the general illumination lighting in a room. Again, it is not described for use with decorative art object illumination. Similarly, Eckel, U.S. Pat. Nos. 5,699,243 and 5,946,209 and Batko, U.S. Pat. No. 6,151,529, both describe motion sensing systems with adaptive timing for controlling lighting fixtures; also intended for general lighting illumination, not decorative illumination of art objects.

Ness, U.S. Pat. No. 5,763,872 describes a motion-actuated night-light. But this is not a fixture/object intended for decorative illumination of art objects. Additionally, the night-light is intended for general illumination of a hall, path, area, or walkway, and not for decorative or aesthetical purposes.

Privas, U.S. Pat. No. 6,390,648, describes a display apparatus for works of art. This system's intended use is for illumination of paintings, photographs, and other works of art that, in and of them self, are not illuminated. An integral part of the present invention is self-illumination versus being used to illuminate other objects: the motion sensor and light source are built-in to the object for the intended purpose of illuminating itself, not some other object. Similarly, Hanis, U.S. Pat. No. 7,204,614, describes a portable, automated illumination device for illuminating external objects such as glasses on a nightstand for the purpose of being able to easily locate these items in the dark.

Mitzel, U.S. Pat. No. 6,402,338 describes an enclosure illumination system primarily intended for illuminating mailboxes and outhouses, but not decorative illumination of wall-mountable art objects.

### SUMMARY OF THE INVENTION

The invention involves an object, such as a cross or crucifix, that utilizes a PIR (Passive Infrared) motion sensor that is used to detect motion in the vicinity of the apparatus. A microcontroller and/or electronic circuitry interpret the motion and then control the LEDs (Light Emitting Diodes) or light source so as to illuminate the object, cross or crucifix with a decorative light pattern. Batteries or an AC/DC converting circuit may be used to power the light source and circuitry.

### BRIEF DESCRIPTION OF THE DRAWINGS

FIG. 1A provides a front view of the preferred embodiment.

FIG. 1B provides a side/sectional view of the preferred embodiment.

FIG. 1C provides a back view of the preferred embodiment.

FIG. 2 shows the electrical schematic block diagram.

FIG. 3 shows the operational flow of the primary system microcontroller software.

### DETAILED DESCRIPTION OF THE PREFERRED EMOBIDMENT

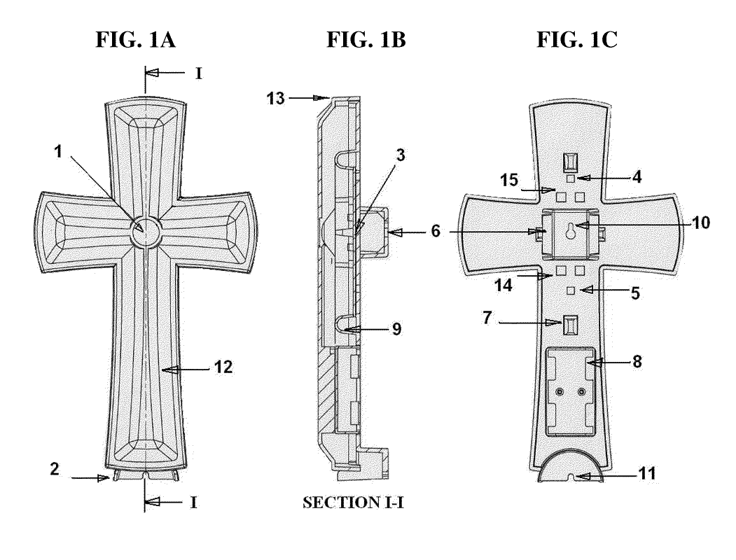

Detailed drawings of the preferred embodiment of the present invention are shown in FIG. 1. Embodiments of the present invention can be employed in any wall-mounted or freestanding object. For purposes of description herein, a cross or crucifix is illustrated. The preferred embodiment of the present invention is approximately ten inches in height, but may be of varying sizes, colors, and shapes. The present invention contains a base 2 that is utilized in freestanding applications, such as when the apparatus is set on a table, dresser, shelf, or other horizontal surface. The present invention may also contain a removable wall mount 6 that can be utilized when mounting the present invention to a wall, door, or other vertical surface. Other embodiments of the present invention may contain a permanently fixed wall mount 6, or removable base 2.

Embodiments of the present invention contain a Fresnel lens 1 in the middle of the cross to increase the range of the PIR motion sensor 3. Other embodiments of the present invention may not include a Fresnel lens 1, or may include lenses 1 of different shapes, sizes, and colors. Other embodiments of the present invention may also include Fresnel lenses 1 and PIR motion sensors 3 mounted in different locations. The enclosure opening for the Fresnel lens 1 is circular in shape and approximately 20 mm in diameter. Other embodiments of the present invention may have different shaped enclosure openings for the Fresnel lens 1. As an example, the opening may also be shaped like a small “cross” with the Fresnel lens 1 mounted behind the opening to make a “cross within a cross” pattern. Other embodiments of the present invention may have square or diamond shaped enclosure openings for the Fresnel lens 1.

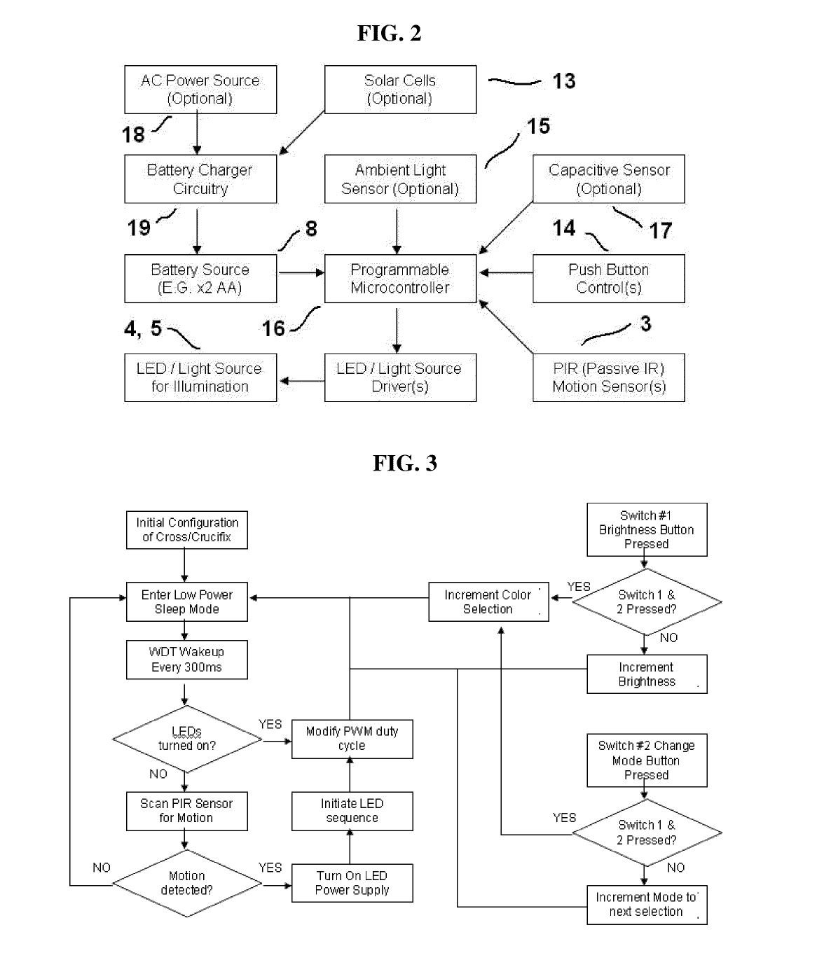

The present invention includes a PIR (Passive Infrared) motion sensor 3 that is used to detect motion in the vicinity of the apparatus. A microcontroller 16 interprets the motion and controls the LEDs (Light Emitting Diodes) 4, 5 behind the present invention so as to illuminate the present invention. FIG. 2 shows the electrical schematic block diagram.

In the preferred embodiment of the present invention, two Red-Green-Blue LEDs 4, 5 are utilized: one above the cross member and one below the cross member so as to produce a uniform, radiant light pattern on the area behind the apparatus. The Red-Green-Blue LEDs 4, 5 can be controlled in a variety of different combinations by the microcontroller 16 so as to produce a variety of colors other than just Red, Green, Blue, and White. Other embodiments of the present invention may include more (or fewer) LEDs of varying colors to produce different radiant light patterns and of varying colors. Other embodiments of the present invention may use light sources other than LED technology. Other embodiments of the present invention may contain multiple LEDs around the edge of the cross so as to produce an “edge” backlit effect. Different LED placements will allow for different LED illumination patterns. Other embodiments of the present invention containing multiple LEDs around the perimeter may contain more complex microcontroller 16—control algorithms that allow for “chasing” patterns. In “chasing” patterns, individual LEDs are brightened or dimmed in a sequential or controlled pattern starting at (for example) the bottom of the present invention and then continuing around the top edge. Other embodiments of the present invention may execute bright flash momentary pulses of the LEDs when motion is detected in the vicinity of the present invention. The preferred embodiment of the present invention will slowly fade the LEDs 4, 5 on and then off so as to create a subtle decorative lighting effect.

In the present invention, the microcontroller 16 may place itself into a low-power sleep mode and only wake once every 300-500 mS to monitor the PIR motion sensor 3 and manipulate the LED light sources 4, 5 accordingly. FIG. 3 shows a detailed flow diagram of the operation of the microcontroller 16 code. The microcontroller 16 code begins by initializing the appropriate default settings. The microcontroller 16 then places itself into a low power sleep mode to save power. It wakes itself using its internal Watch Dog Timer approximately every 300 ms-500 ms and first checks to see if a lighting sequence is already being executed. If a lighting sequence is already executing, then the microcontroller 16 modifies the light source signals appropriately (example: further dims or brightens the light source), and then places itself back into sleep mode. If no light source sequence is being timed, then it scans the PIR motion sensor 3 to see if motion is detected. If motion is detected, the microcontroller 16 enables the light source power supply and initiates a new lighting sequence. If no motion is detected, the microcontroller 16 places itself back into sleep mode to wait for the next scan period. The user accessible switches 14 may be used to trigger interrupts at any time to wake the microcontroller 16 from sleep mode and increment or decrement user selectable features of the present invention. After the user has made the modifications, the microcontroller 16 then places itself back into a low power sleep mode.

Other embodiments of the present invention may contain additional circuitry to monitor the ambient light sensor 15 and modify the monitoring period(s) and LED light source 4, 5 manipulation accordingly. The ambient light sensor 15 could be placed in the front panel of the present invention to allow for optimal light sensing. In the event the ambient light 15 sensor detects low light conditions or increasing darkness, the LED drive current may be decreased. In the event the ambient light sensor 15 detects high light conditions or increasing brightness, the LED drive current may be increased to allow for greater visibility. In the event the ambient light sensor 15 detects extremely bright light conditions, the LEDs 4, 5 may be completely disabled to save power for more ideal or lower brightness operating conditions. Other embodiments of the present invention may wake from low power sleep mode as infrequently as once per second or longer to monitor the PIR motion sensor 3 and manipulate light sources 4, 5 accordingly.

Embodiments of the present invention contain two switches 14 to allow for user input and configuration of the apparatus operation. For example, the user can set the “on time” of the light source(s) 4, 5, or the minimum time between detections/trips. The switches 14 may also be used to set the preferred LED color (created from combining the Red-Green-Blue LEDs) 4, 5. Seven pre-programmed LED colors will be selectable in the preferred embodiment: 1) Red, 2) Green, 3) Blue, 4) Purple, 5) Teal (blue-green), 6) Yellow, and 7) White. A final mode of operation selectable by the user input switches 14 allows the user to place the present invention into a “cycling color” mode. In this mode of operation, the LED color will rotate (randomly) through each of the available colors automatically each time the present invention detects motion in the vicinity of the PIR motion sensor 3. This mode may also be used as a demonstration mode for when a single product is placed in a store display. Subsequent reduced feature versions of the present invention may only include single color LEDs 4, 5 such as white for simplicity of use and to reduce manufacturing costs. The switches 14 may also be used to select from among a set of preconfigured operating modes which would set things such as the 1) brightness of the LEDs 4, 5, 2) time between trips, and 3) LED 4, 5 color(s). A 3^{rd} switch may also be included for on/off control to completely disconnect the battery or power source from the electronic circuitry. Other embodiments of the present invention may contain an on/off switch and more (or less) user controls/switches.

Other embodiments of the present invention may utilize capacitive-touch 17 and proximity sensing technology for one of three possible uses: 1) to replace the user switches 14 with capacitive-touch switches 17, 2) to manipulate the pattern or brightness of the light sources 4, 5, and/or 3) detect motion or the presence of a person or object in the vicinity of the present invention in order to modify operation (example: brighten or dim the LEDs 4, 5). Because capacitive touch sensing can provide a more absolute measurement change (example: the digital reading gets larger as a person or infrared emitting object gets closer), it will be possible for the LED 4, 5 brightness to be “synchronized” to the distance an object or person is from the present invention. As an example, as a person approaches the present invention, the capacitive sensing 17 could be used to detect the increase in the capacitive field and increase the LED 4, 5 brightness as the person gets closer. Similarly, the LEDs 4, 5 would be dimmed as the person moved further away from the apparatus.

In yet another embodiment of the present invention the user may hold down one of the switches 14, and the microcontroller 16 will scan/toggle through a variety of pre-configured color combinations until the user releases the switch 14 once they select the ideal LED 4, 5 color for matching their desired room décor. As an example, if the user desires a yellowish-orange LED light color to match a kitchen room décor, they would press the appropriate color selection switch 14 and hold it, at which point the microcontroller 16 would start slowly cycling through a predefined color pallet (or color wheel) containing a predetermined set of color combinations. When the user reaches the desired hue of yellowish-orange, releasing the switch 14 automatically sets that color into the microcontroller 16 memory. Subsequent trips of the present invention would result in the LEDs 4, 5 illuminating in that color set by the user (yellowish-orange in this example).

The preferred embodiment of the present invention uses two “AA” sized alkaline batteries to power the LEDs 4, 5. Other embodiments of the present invention may include circuitry to allow operation from various other battery sizes, types, and chemistries. Three “AA” batteries may be adapted to add battery life to other embodiments of the present invention. Other embodiments of the present invention may include circuitry that would allow for operation from an AC power source 18. Other embodiments of the present invention may also include charger circuitry 19 to allow operation from user rechargeable batteries or power sources.

Another embodiment of the present invention may allow the apparatus to be charged using “wireless” charging technology. A transformer in the apparatus would detect the presence of a compatible recharging base near the apparatus and allow for recharging of the battery or power source. Another embodiment of the present invention would allow the batteries of the apparatus to be charged using solar cells 13 mounted on the apparatus. The solar cells 13 would be mounted on top of the present invention to maximize ambient light energy for recharging the rechargeable cells in the unit without having to remove them.

The preferred embodiment of the present invention includes user access to the battery compartment 8 for service/replacement of the batteries. Other embodiments of the present invention may include sealed case versions for use both indoors and outdoors. Other embodiments of the present invention may be sealed “water-tight” or “submersible.”

The preferred embodiment of the present invention includes a Printed Circuit Board 7 secured by hooks 9 molded into the enclosure/assembly body 12 without the use of screws, fasteners, or other hardware. An upper keyhole 10 for hanging or mounting the present invention to a wall or vertical surface is included in addition to a lower mounting hole 11 that can be used to more securely mount the enclosure/assembly body 12 to a vertical wall or surface that may move, such as a door or window.

Outdoor or industrial versions of the present invention may have a larger cross or crucifix size, more LEDs or light sources, higher power LEDs or light sources, a microcontroller 16 with more input/output pins and memory, a larger power source such as a sealed lead acid battery, a larger Fresnel lens 1 for detecting motion at a greater distance, and a different mounting topology.

What is claimed is:

1. A wall mountable decorative object, such as a crucifix or cross, comprised of:
A base mount that allows the object to stand vertically or to be mounted on a vertical surface such as a wall;
A motion sensor, such as a Passive Infrared (PIR) sensor, used to detect motion in the vicinity of the decorative object;
A lens, such as a Fresnel lens, for the purpose of concentrating infrared energy onto the PIR sensor to enhance the active detection range of the sensor;
LEDs (Light Emitting Diodes) or light sources for the purpose of illuminating the object in a decorative fashion;
A circuit for interpreting the motion sensor and illuminating the object in a decorative fashion for a period of time once motion is detected near the object;
A battery or power source for supplying power to the system and light source
One or more programming switches or sensors for changing the brightness, color, mode of operation, and/or on time of the light source

2. An object as described in claim 1 having a removable back wall mount

3. An object as described in claim 1 having RGB (Red/Green/Blue) LEDs for the purpose of illuminating the surrounding area in multiple decorative colors

4. An object as described in claim 1 having hooks molded into the enclosure that secure the Printed Circuit Board in place without the use of screws or fasters

5. An object as described in claim 1 having an ambient light sensor used to detect changes in ambient light conditions and adjust the brightness of or disable the light source output

6. An object as described in claim 1 having an electrical converter circuit for supplying current from a standard AC wall outlet

7. An object as described in claim 1 having solar cells and inverting circuit for generating current from the solar cells

8. An object as described in claim 1 having a rechargeable power source and associated charge circuitry

9. An object as described in claim 1 having a keyhole for hanging on a nail, screw or other fastener when mounting to vertical surfaces

10. A wall mountable decorative object comprised of:
A base mount that allows the object to stand vertically or to be mounted on a vertical surface such as a wall;
A motion sensor, such as a Passive Infrared (PIR) sensor, used to detect motion in the vicinity of the object;
A lens, such as a Fresnel lens, for the purpose of concentrating infrared energy onto the PIR sensor to enhance the active detection range of the sensor;
LEDs (Light Emitting Diodes) or light sources for the purpose of illuminating the object in a decorative fashion;
A circuit for interpreting the motion sensor and illuminating the light source in a decorative fashion for a period of time once motion is detected near the object;
A battery or power source for supplying power to the system and light source
One or more programming switches or sensors for changing the brightness, color, mode of operation, and/or on time of the light source

11. An object as described in claim 10 having a removable back wall mount

12. An object as described in claim 10 having RGB (Red/Green/Blue) LEDs for the purpose of illuminating the surrounding area in multiple decorative colors

13. An object as described in claim 10 having hooks molded into the enclosure that secure the Printed Circuit Board in place without the use of screws or fasters

14. An object as described in claim 10 having an ambient light sensor used to detect changes in ambient light conditions and adjust the brightness of or disable the light source output

15. An object as described in claim 10 having an electrical converter circuit for supplying current from a standard AC wall outlet

16. An object as described in claim 10 having solar cells and inverting circuit for generating current from the solar cells

17. An object as described in claim 10 having a rechargeable power source and associated charge circuitry

18. An object as described in claim 10 having a keyhole for hanging on a nail, screw or other fastener when mounting to vertical surfaces

19. A wall mountable decorative object comprised of:
A base mount that allows the object to stand vertically or to be mounted on a vertical surface such as a wall;
A motion sensor, such as a Passive Infrared (PIR) sensor, used to detect motion in the vicinity of the object;
A lens, such as a Fresnel lens, for the purpose of concentrating infrared energy onto the PIR sensor to enhance the active detection range of the sensor;
LEDs (Light Emitting Diodes) or light sources for the purpose of illuminating the object in a decorative fashion;
A circuit for interpreting the motion sensor and illuminating the light source in a decorative fashion for a period of time once motion is detected near the object;
A battery or power source for supplying power to the system and light source
One or more programming switches or sensors for changing the brightness, color, mode of operation, and/or on time of the light source
